(19) United States
(12) Patent Application Publication
(10) Pub. No.: US 2025/0004954 A1
(43) Pub. Date: Jan. 2, 2025

(54) REAL-TIME PERIPHERALS

(71) Applicant: Nordic Semiconductor ASA, Trondheim (NO)

(72) Inventors: Frode Milch PEDERSEN, Trondheim (NO); Jean-Baptiste BRELOT, CHAMPDIVERS (FR)

(21) Appl. No.: 18/707,064

(22) PCT Filed: Nov. 4, 2022
(86) PCT No.: PCT/EP2022/080765

§ 371 Date: May 2, 2024

(30) Foreign Application Priority Data
Nov. 4, 2021 (FI) 20216136

(51) Int. Cl. G06F 13/10

(52) U.S. Cl. CPC G06F 13/10; G06F 2213/40

(57) ABSTRACT

According to an aspect, there is provided a solution for controlling communication in a processor arrangement, the arrangement comprising a core processor, a peripheral unit operationally connected to the core processor; a given number of input/output unit lines, the arrangement being further connectable to external peripherals. The solution comprises performing down-counting (600) utilising at least one counter of two down-counters of a given length, generating (602) an event when a counter reaches zero value and synchronizing (604) signalling on input/output unit lines and communication of core processor with external peripherals on the basis of the event.

### TECHNICAL FIELD

Various example embodiments relate to processors and real-time peripherals of processors.

### BACKGROUND

In computing design one of the main goals is to realise reliable and fast operation of devices. In modern computing design processors and central processing units, CPUs, may be connected to many peripherals which perform tasks controlled by the CPU. The communication and control of the peripherals should be as fast as possible to enable efficient and flexible operation of both the CPU and peripherals.

### BRIEF DESCRIPTION

According to an aspect, there is provided a processor arrangement, comprising a core processor, a peripheral unit operationally connected to the core processor; a given number of input/output unit lines, the arrangement being further connectable to external peripherals, the peripheral unit comprising two down-counters of a given length, the arrangement being configured to generate an event when a counter reaches zero value, the event synchronizing signaling on input/output unit lines and communication of core processor with external peripherals.

According to another aspect, there is provided a method for controlling communication in a processor arrangement, the arrangement comprising a core processor, a peripheral unit operationally connected to the core processor; a given number of input/output unit lines, the arrangement being further connectable to external peripherals, the method comprising performing down-counting utilising at least one counter of two down-counters of a given length, generating an event when a counter reaches zero value, synchronizing signaling on input/output unit lines and communication of core processor with external peripherals on the basis of the event.

One of the advantages provided by the aspects is that they enable cycle-correct interaction with input/output unit lines and external peripherals and the core processor.

In an embodiment, the two down-counters of a given length may be configured to act as a single counter having double the given length.

In an embodiment, the peripheral unit comprising one or more registers, the operation of registers being synchronized by the events from a counter of the two down-counters, the values of the registers being written or read by the core processor.

In an embodiment, the peripheral unit comprises a TOP register, a down-counter being configured to load the value of the TOP register and start down-counting from the value in the TOP register.

In an embodiment, the peripheral unit comprises a DIR, IN and OUT registers, the core processor being configured to set the values of the DIR and OUT registers, and when an event occurs, if the value of the DIR register is one, the arrangement is configured to write the value of the OUT register to an input/output unit line; and if the value of the DIR register is zero, the arrangement is configured to sample a value from an input/output unit line to the IN register.

In an embodiment, the peripheral unit comprises buffered DIRB and OUTB registers, the core processor being configured to set the values of the DIRB and OUTB registers and copy the value of DIRB to DIR and the value of OUTB to OUT when an event occurs.

In an embodiment, at least one of the two down-counters is configured to, when reaching zero value, perform one of the following: load the value of the TOP register into the counter and start down-counting, stop counting.

In an embodiment, the peripheral unit comprises a CNTADD alias register, and wherein at least one of the two down-counters is configured to, when reaching zero value continue down-counting, and when the CNTADD comprises a non-zero value add the value to the value of the counter and continue down-counting.

In an embodiment, the core processor is stalled if the processor attempts to write to a buffered register DIRB or OUTB, from which a previous value has not been copied to corresponding DIR or OUT register.

In an embodiment, the event is an event pulse.

The scope of protection sought for various embodiments is set out by the independent claims.

The embodiments and features, if any, described in this specification that do not fall under the scope of the independent claims are to be interpreted as examples useful for understanding various embodiments of the invention.

### BRIEF DESCRIPTION OF DRAWINGS

In the following, example embodiments will be described in greater detail with reference to the attached drawings, in which

FIG. 1 illustrates an example of a processing arrangement;

FIG. 2 illustrates an example of a peripheral unit;

FIG. 3 illustrates an example of the operation of a timer module and an input/output module;

FIG. 4 illustrates an example of the operation of counters;

FIG. 5 illustrates an example of serial peripheral interface data transfer; and

FIG. 6 is a flowchart illustrating an embodiment.

### DETAILED DESCRIPTION OF SOME EMBODIMENTS

Processor arrangements may be designed for numerous purposes with different designs. Typically, a processor arrangement comprises a core processor and a number of modules connected to the core processor. The processor arrangement may be Central Processing Units CPUs, Digital Signal Processors (DSPs), Direct Memory Access (DMA) modules or any other apparatus.

FIG. 1 illustrates an example of a processor arrangement or circuitry 100 where embodiments of the invention may be applied.

In the example of FIG. 1, the processor arrangement or circuitry 100 comprises a core processor 102 and a number of modules 104, 106, 108, 110 operationally connected to the core processor. The arrangement 100 may also comprise other components, such as buses or interfaces but they are not shown here for clarity.

The core processor 102 controls the operation of the processor arrangement and communicates with the modules 104, 106, 108, 110. The modules comprise a debug module 104 which implements registers for sending abstract commends to the core processor. The Core Level Interrupt Controller CLIC 108 manages interrupts 116. The Power and Clock Generic Controller PCGC 110 manages interfacing to power management system.

The peripheral unit 106 is configured to control communication with peripherals 114 external to the processing arrangement and input/output unit lines 112 connected to the processing arrangement.

Typically, a processing arrangement or circuitry comprises a number of general input/output, GPIO, signal pins or lines which may be used for inputting or outputting data and which may be controlled at runtime by software. Communication of the core processor using the GPIO or with the external peripherals should be as fast and reliable as possible.

Controlling timing is a vital element of the communication. Traditional timers are designed as standalone timer functions. They are not tightly coupled to the core processor or GPIO need significant overhead to be serviced by software to allow the flexibility required by a general-purpose protocol emulation. Therefore, traditional realisation of protocol emulation relies on direct manipulation of GPIO by the core processor. This requires cycle-correct execution since any jitter in the instruction stream would otherwise propagate to the GPIOs. This either requires dedicated memories or running the core processor without any memory optimization.

In another known method, protocols can be emulated with embedded field-programmable grid arrays, FPGAs, but these are extremely expensive in terms of silicon area.

To achieve high resolution peripheral emulation and low cost of the peripheral extension, an embodiment provides a processor arrangement 100, comprising a core processor 102, a peripheral unit 106 operationally connected to the core processor; and a given number of input/output unit lines 112, the arrangement being further connectable to external peripherals 114. The peripheral unit comprises two down-counters of a given length, and the arrangement is configured to generate an event when a counter reaches zero value. The event is utilised to synchronize signaling on input/output unit lines and communication with external peripherals. This enables cycle-correct interaction with input/output unit lines and external peripherals.

When processors are used in a shared memory system, some jitter in the instruction execution is inevitable, even if a certain memory latency and bandwidth is guaranteed. In the proposed solution, the peripheral unit is designed to allow precisely controlled GPIO interaction despite the inevitable jitter in the instruction execution.

The external peripherals retain the flexibility of full core processor control but offload the core processor with low-level timing. This allows higher resolution of the emulated protocol, and less load on the core processor.

The combination of high resolution and low cost makes it practical to include a dedicated core processor instance with the real-time peripheral extension for protocol emulation. This can replace the need for traditional complex peripherals, while offering great flexibility in adapting to future needs without changing the silicon.

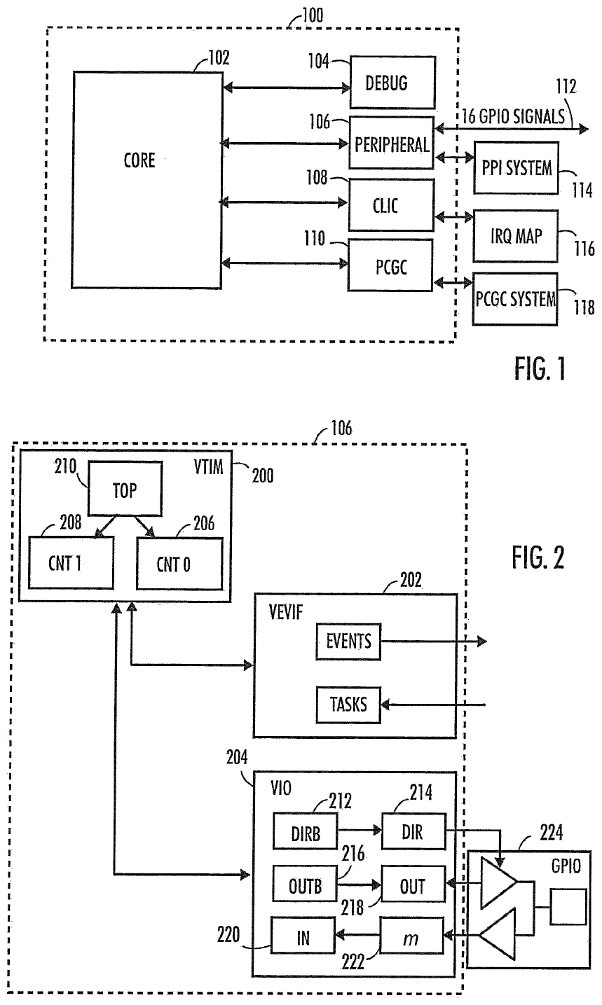

FIG. 2 illustrates an example of structure of the peripheral unit 106 operationally connected to the core processor 100.

The peripheral unit 106 comprises a timer module VTIM 200, an Event interface VEVIF 202 and Input/Output module VIO 204 operationally connected with each other. The Timer module 200 comprises two down-counters CNT0 206 and CNT1 208 of a given length. The Timer further comprises a TOP register 210. The timer may also be operationally connected to the TOP register.

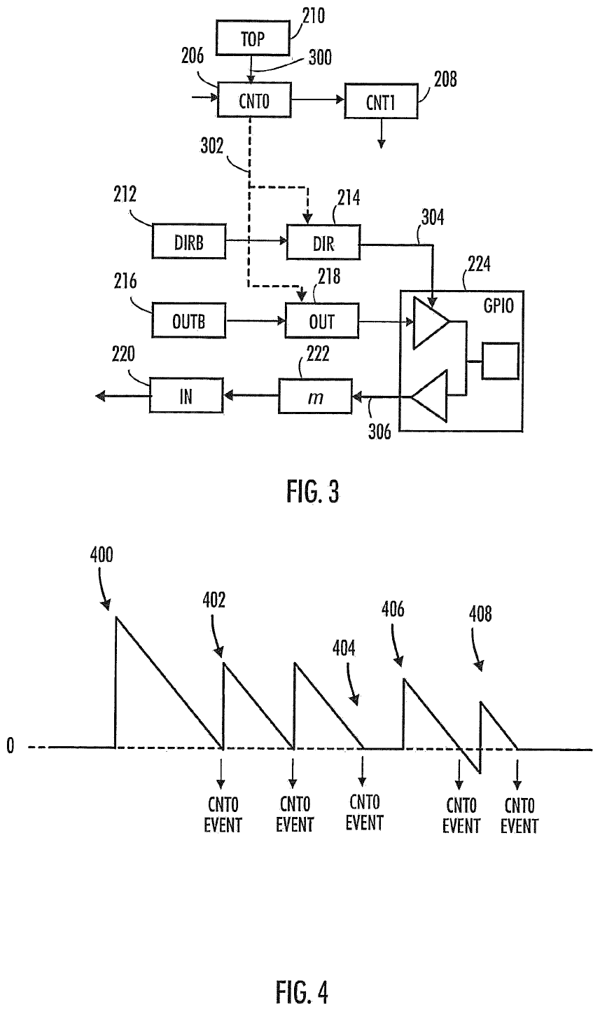

In an embodiment, the Input/Output module VIO 204 may be a GPIO controller with support for up to 16 GPIO pins or more. The connection between VIO signals and specific GPIO pads 224 may be defined at the system level and are typically not programmable. VIO is clocked on the CPU clock. The VIO comprises registers DIRB 212, DIR 214, OUTB 216, OUT 218, IN 220 and m 222. The operation of VIO and the timer module VTIM 200 is described below in connection with FIG. 3.

The Event interface module VEVIF 202 allows interaction with peripherals via a Programmable Peripheral Interconnect, PPI, system in the domain where the processing arrangement is instantiated. The Event interface module VEVIF 202 can also generate interruptions, IRQs, to other core processors. In an embodiment, the peripheral unit 106 operates on the core processor clock.

In an embodiment, the Timer 100 allows cycle-accurate timing measurement and control and can be used to synchronize the Input/Output module VIO 204. The Input/Output module VIO 204 may be designed for precise timing control of GPIO.

In an embodiment, the two down-counters CNT0 206 and CNT1 208 of the timer module VTIM 200 are 16-bit down-counters. In an embodiment, the counters can act independently as CNT0 and CNT1. Alternatively, they may operate in conjunction as one 32-bit counter CNT0. The length of the counters is not limited to 16 bits but may be selected depending on the application as one skilled in the art is aware.

A counter starts counting when a counter CNTx is written with a non-zero value. When the counter reaches 0, an event pulse is generated.

FIG. 3 illustrates an example of the operation of the timer module VTIM 200 and the Input/Output module VIO 204.

As mentioned, the peripheral unit comprises registers DIRB 212, DIR 214, OUTB 216, OUT 218, IN 220 and m 222. In an embodiment, the core processor may be configured to set the values of the DIR and OUT registers.

In this example, the down-counter CNT0 206 is loaded 300 with the value from TOP register. The counter will start down-counting or decrement its value every cycle until it becomes zero. At that time an Event, Cnt0Event 302, occurs. The event may trigger an increment in the other counter CNT1 208 or be used to synchronize other registers.

The DIR register is used to denote whether communication is away from the apparatus or towards to the apparatus, i.e., whether a writing or reading operation is in question.

In this example, when the event Cnt0Event 302 occurs, if the value of the DIR 214 register is one, the output buffer of the GPIO 224 is enabled and the arrangement is configured to write 304 the value of the OUT register to an input/output unit line of the GPIO 224. In an embodiment, the core processor—can write directly to DIR and OUT registers, in which case these registers may be updated immediately when the write occurs. Alternatively, the core processor may write to the buffered value of these registers (DIRB 212 and OUTB 216). The values of these registers are then copied to DIR 214 and OUT 218 on the next Cnt0Event.

If the value of the DIR register 214 is zero, the arrangement is configured to sample 306 a value from an input/output unit line of the GPIO 224 to the IN register. In an embodiment, the input from each pin of GPIO 224 is sampled by an input flop m 222 to resolve metastability and is then captured by the IN register 220. The IN register can capture on every clock cycle, or optionally only on a Cnt0Event.

In an embodiment, the core processor is stalled if the processor attempts to write to a buffered register DIRB or OUTB, from which a previous value has not been copied to corresponding DIR or OUT register. This prevents the previous value to be overrun and provides an efficient synching between the core processor and Real-Time Peripherals without need for the core processor to loop and poll for the dirty status of the buffer register. This allows a very high output rate, allowing high-speed peripheral emulation.

In an embodiment, the above operations are mapped to core processor space for single-cycle access.

In an embodiment, the operation of the counters CNT0 206, CNT1 208 may be controlled by a mode variable or register value. The apparatus may comprise a CNTMODEx register for CNTx storing the mode of the corresponding counter.

In an embodiment, the mode variable may comprise the values of Stop, Wrap, Reload and Trigcomb.

If the counter mode is Stop, the counter is configured to stop when value 0 is reached. If the counter mode is Wrap, the counter is configured to continue counting from 0xFFFF after reaching value 0.

If the counter mode is Reload, the counter is configured to continue from the value in the TOP register after reaching value 0.

If the counter mode is Trigcomb, counter CNT0 supports Trigger mode: Counting stops at 0. Counting will restart when an Event triggers. Counter CNT1 supports Combine mode: CNT1 will act as the 16 MSBs of CNT0. If CNT0 is in wrap mode, it wraps to 0xFFFF_FFFF.

FIG. 4 illustrates an example of the operation of the counters CNT0, CNT1 207, 208.

At time instant 400, CNT0 starts down-counting from the value in the TOP register and counts until it reaches value 0, at which time an event, Cnt0Event, is produced.

The next behaviour of the counter CNT0 depends on the mode setting of the counter. If Mode=Reload, CNT0 is loaded with TOP, and the sequence starts over.

In the example of FIG. 4, the Mode is reload and the counter CNT0 starts at time instant 402 down-counting from the value in the TOP register (which in this example is smaller than in time instant 400). By time instant 404, the Mode has changed to Stop. This means that when the value 0 is reached the counter CNT0 stops counting.

At time instant 406, CNT0 starts down-counting from the value in the TOP register and counts until it reaches value 0, at which time an event, Cnt0Event, is produced at time instant 408 the Mode has changed to Wrap. If Mode=Wrap, CNT0 is not reloaded, but it keeps decrementing, effectively becoming a negative value.

In an embodiment, an alias register, CNTADDx, may be utilised in updating the value of the counter. Writing to the CNTADDx register will add the value to the respective counter CNTx, allowing the counter to be updated with an offset while the counter is down-counting. In an embodiment, if the CNTADDx register is written at cycle n, CNTx will be updated in the next cycle as follows: CNTx(n+1)=CNTx(n)+CNTADDx−1.

The wrap-mode is beneficial in cases when the reload value may not be known at the time the counter reaches value 0. This gives software time to decide the new reload value and write the value to the CNTADDx register. This will add the reload value to the CNTx value without changing the value of the TOP register.

In FIG. 4, CNTADD0 register is updated at time instant 408, after which the counter CNT0 keeps decrementing until value 0, resulting a new Event. This will then occur a number of cycles after the previous Event precisely defined by the reload value which was written to CNTADD0.

Wrap mode in combination with the CNTADDx register thus allows the counter period to be precisely defined even in the middle of an ongoing counter period.

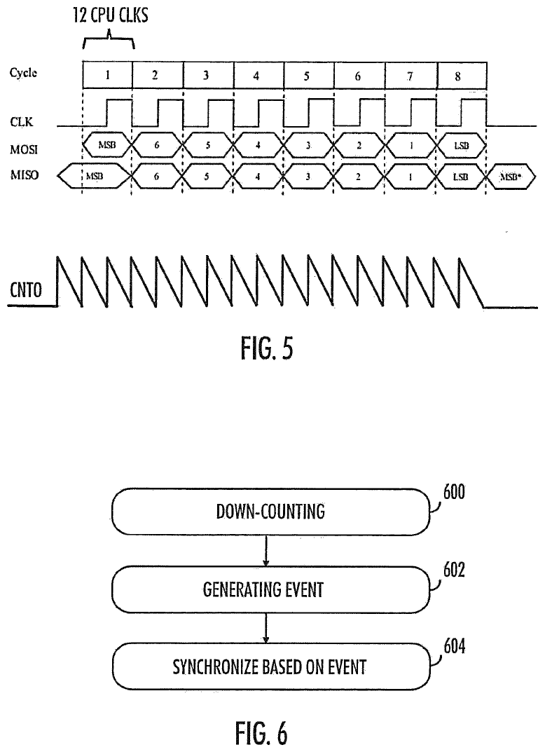

FIG. 5 and following source code snippet illustrate an example of Serial Peripheral Interface, SPI, data transfer between a master and a slave where the counters are utilised.

```
uint8_t spi_transfer_byte(uint8_t byte){
  //Shift MOSI bit out
  if(byte & (1<<7)){
    csr_set(VIO_OUT, 1 << MOSI_PIN);
  } else{
    csr_clear(VIO_OUT, 1 << MOSI_PIN);
  }
  //Set counter to the start of a cycle
  csr_write(VTIM_CNT, SCLK_PRESCALER);
  for(int i = 7; i > −1; i−−){
    //Buffer set sclk
    csr_set(VIO_OUTB, 1<<SCLK_PIN);
    //Buffer clear sclk and shift MOSI bit out
    if(byte & (1<<6)){
      csr_write(VIO_OUTB, (1<<MOSI_PIN)|(csr_read(VIO_OUT) & ~(1<<SCLK_PIN)));
    } else{
      csr_clear(VIO_OUTB, (1 << MOSI_PIN)|(1<<SCLK_PIN));
    }
    //Shift MISO bit in
    byte = (byte<<1)|((csr_read(VIO_IN)&(1<<MISO_PIN))>>MISO_PIN);
  }
  //Make sure clock is idle
  if(CLK_POLARITY){ csr_set(VIO_OUTB, 1<<SCLK_PIN);
  } else{
    csr_clear(VIO_OUTB, 1<<SCLK_PIN);
  }
  return byte;
}
```

The SPI protocol is full duplex, so the master simultaneously drives out one byte on MOSI (Master Out Slave In) while receiving another on MISO (Master In Slave Out). The master also drives out the clock on CLK. The example shows regular polarity, with MOSI driven on falling CLK and MISO sampled on rising CLK.

In an embodiment, CNT0 TOP register is preloaded with a value SCLK_PRESCALER corresponding to the number of clock cycles corresponding to half the CLK period. In the source code example above, OUT register is loaded with the most significant bit, MSB, before the CNT0 is started (by manually writing SCK_PRESCALER to CNT0).

The remaining bits in the byte are covered by 8 passes through the for loop: First SCK is written to 1 in OUTB. This buffered value will go into effect on the next Cnt0Event (i.e. middle of the bit period). Next, SCK is cleared and the MSB of byte is written to OUTB as the next MOSI value. It may be noted that OUTB is written to for the second time, while still waiting for the first value to be transferred to OUT because Cnt0Event has not happened yet. The CPU will then stall until Cnt0Event occurs, at which point OUTB is freed up to receive new write, which remains buffered until the following Cnt0Event (i.e. at the end of the bit period, where SCK shall have a falling edge).

The MISO pin is then sampled from VIO_IN and byte shifted left one position. This will occur immediately after the rising edge of SCK.

The net effect is that the 8-bit byte variable will have changed from containing the byte to be transmitted on MOSI, to containing the byte which was received on MISO. Meanwhile, all SCK and MOSI timings of the protocol have been respected.

The proposed solution translates close timing into a cycle-accurate timing. This allows complex real-time emulation to be obtained with great flexibility and minimum hardware.

FIG. 6 is a flowchart illustrating an embodiment. The flowchart illustrates the operation of a processor arrangement comprising a core processor, a peripheral unit operationally connected to the core processor; a given number of input/output unit lines, the arrangement being further connectable to external peripherals

In step 600, down-counting is performed utilising at least one counter of two down-counters of a given length.

In step 602, an event is generated when a counter reaches zero value.

In step 604, signaling on input/output unit lines and communication of core processor with external peripherals is synchronized on the basis of the event.

As used in this application, the term ‘circuitry’ refers to one or more of the following: hardware-only circuit implementations such as implementations in only analogue and/or digital circuitry; combinations of hardware circuits and software and/or firmware; and circuits such as a microprocessor(s) or a portion of a microprocessor(s) that require software or firmware for operation, even if the software or firmware is not physically present. This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

It will be obvious to a person skilled in the art that, as technology advances, the inventive concept can be implemented in various ways. Embodiments are not limited to the examples described above but may vary within the scope of the claims.

1. A processor arrangement, comprising a core processor, a peripheral unit operationally connected to the core processor; a given number of input/output unit lines, the arrangement being further connectable to external peripherals,
the peripheral unit comprising two down-counters of a given length, the arrangement being configured to generate an event when a counter reaches zero value, the event synchronizing signaling on input/output unit lines and communication of core processor with external peripherals.

2. The processor arrangement of claim 1, wherein the two down-counters of a given length may be configured to act as a single counter having double the given length.

3. The processor arrangement of claim 1, the peripheral unit comprising one or more registers, the operation of registers being synchronized by the events from a counter of the two down-counters, the values of the registers being written or read by the core processor.

4. The processor arrangement of claim 1, wherein the peripheral unit comprises a TOP register, a down-counter being configured to load the value of the TOP register and start down-counting from the value in the TOP register.

5. The processor arrangement of claim 1, wherein the peripheral unit comprises a DIR, IN and OUT registers, the core processor being configured to set the values of the DIR and OUT registers;
and when an event occurs,
if the value of the DIR register is one, the arrangement is configured to write the value of the OUT register to an input/output unit line; and
if the value of the DIR register is zero, the arrangement is configured to sample a value from an input/output unit line to the IN register.

6. The processor arrangement of claim 5, wherein the peripheral unit comprises buffered DIRB and OUTB registers, the core processor being configured to set the values of the DIRB and OUTB registers and copy the value of DIRB to DIR and the value of OUTB to OUT when an event occurs.

7. The processor arrangement of claim 1, wherein at least one of the two down-counters is configured to, when reaching zero value, perform one of the following:
load the value of the TOP register into the counter and start down-counting;
stop counting.

8. The processor arrangement of claim 1, wherein the peripheral unit comprises a CNTADD alias register, and wherein at least one of the two down-counters is configured to, when reaching zero value continue down-counting, and when the CNTADD comprises a non-zero value add the value to the value of the counter and continue down-counting.

9. The processor arrangement of claim 6, wherein
the core processor is stalled if the processor attempts to write to a buffered register DIRB or OUTB, from which a previous value has not been copied to corresponding DIR or OUT register.

10. The processor arrangement of claim 1, wherein the event is an event pulse.

11. A method for controlling communication in a processor arrangement, the arrangement comprising a core processor, a peripheral unit operationally connected to the core processor; a given number of input/output unit lines, the arrangement being further connectable to external peripherals, the method comprising
performing down-counting utilising at least one counter of two down-counters of a given length, generating an event when a counter reaches zero value,
synchronizing signaling on input/output unit lines and communication of core processor with external peripherals on the basis of the event.

12. The method of claim 11, further comprising:
synchronizing operation of a set of registers of the arrangement by the events from a counter of the two down-counters, and
writing or reading the values of the registers by the core processor.

13. The method of claim 11, wherein the peripheral unit comprises a TOP register, the method further comprising:
loading by a down-counter the value of the TOP register and start down-counting from the value in the TOP register.

14. The method of claim 11, wherein the peripheral unit comprises a DIR, IN and OUT registers, the method further comprising:
setting the values of the DIR and OUT registers by the core processor;
and when an event occurs,
if the value of the DIR register is one, writing the value of the OUT register to an input/output unit line; and
if the value of the DIR register is zero, sampling a value from an input/output unit line to the IN register.

15. The method of claim 14, wherein the peripheral unit comprises buffered DIRB and OUTB registers, the method further comprising:
setting by the core processor the values of the buffered DIRB and OUTB registers and copy the value of DIRB to DIR and the value of OUTB to OUT when an event occurs.

16. The method of claim 11, wherein at least one of the two down-counters is configured to, when reaching zero value, perform one of the following:
load the value of the TOP register into the counter and start down-counting;
stop counting.

17. The method of claim 11, wherein the peripheral unit comprises an alias CNTADD register, the method further comprising:
when reaching zero value by at least one of the two down-counters, continue down-counting with the at least one of the two down-counters, and when the CNTADD comprises a non-zero value add the value to the value of the at least one of the two down-counters and continue down-counting.

18. The method of claim 14, further comprising
stalling the core processor if the processor attempts to write to a buffered register DIRB or OUTB, from which a previous value has not been copied to corresponding DIR or OUT register.

19. The method of claim 11, wherein the event is an event pulse.
